(19) United States
(12) Patent Application Publication
(10) Pub. No.: US 2008/0195981 A1
(43) Pub. Date: Aug. 14, 2008

(54) SYSTEM AND METHOD FOR CREATING PORTABLE INTERACTIVE MULTIMEDIA PRESENTATIONS

(75) Inventors: Greg Pulier, Beverly Hills, CA (US); John Busfield, Beverly Hills, CA (US)

Correspondence Address: KLEINBERG & LERNER, LLP, 2049 CENTURY PARK EAST, SUITE 1080, LOS ANGELES, CA, 90067, US

(73) Assignee: MEDIAPLATFORM ON-DEMAND, INC., Beverly Hills, CA (US)

(21) Appl. No.: 11/674,293

(22) Filed: Feb. 13, 2007

(51) Int. Cl. G06F 17/00

(52) U.S. Cl. 715/974

(57) ABSTRACT

A system and method for creating portable multimedia presentations permits a user to select slides, select or create video and audio to associate with those slides to thereby create a multimedia presentation. A user may then use this multimedia presentation to create a single audio/video file for portable use incorporating all of the elements of the multimedia presentation suitable for storage and viewing on a portable multimedia device.

### CROSS-REFERENCE TO RELATED APPLICATIONS AND PATENTS

Cross-reference is made to the co-pending patent application with Ser. No. 11/562,377 filed Sep. 21, 2006 and entitled “System and Method For Creating Interactive Digital Audio, Video and Synchronized Media Presentations” owned by the assignee of record of the present application. This application is incorporated in its entirety by reference.

Cross-reference is also made to the issued U.S. Pat. No. 6,834,371 issued on Dec. 21, 2004 entitled “System and Method for Controlling Synchronization of a Time-Based Presentation and it's Associated Assets” owned by the assignee of record of the present application. This patent is incorporated in its entirety by reference.

Further cross-reference is made to the issued U.S. Pat. No. 6,839,059 issued on Jan. 4, 2005 entitled “System and Method for manipulation and Interaction of Time-Based Media Formats” owned by the assignee of record of the present application. This patent is incorporated in its entirety by reference.

### BACKGROUND

1. Field of the Invention

The present invention relates to video and media presentations and more particularly to a system and method for creating portable digital audio, video and synchronized media presentations.

2. Description of the Related Art

For purposes of this application, the word “video” will be understood to refer to audio, video or audio-visual data interchangeably. Video herein should be understood to be interchangeable with any combination of audio and video data or information. The terms “slide” and “image” are to be understood to be interchangeable. They both refer to digital images, PowerPoint® slides, text documents, or other individually viewable data or data capable of review in sequence. This can include slideshows with transitions between slides or interactive portions that may be active for a period of time.

The terms “presentation,” “multimedia presentation” or “media presentation” herein will be understood to mean a combination of any type of slide, such as an image, a PowerPoint® presentation slide, still frames from video data, pages in a text document and similar related media with any type of video, streaming data, downloadable audio-visual media, video-based screen capture or images in rapid succession. This combination of slide and “video” as defined herein will be referred to as a “presentation” or “multimedia presentation” in the context of this application. In the most general sense presentation refers to a time-based media type (audio/video data) driving synchronized changes of other still media (images) types.

The terms “podcast” or “portable video” and similar terms will be understood to refer to a digital file of any number of formats, capable of being viewed upon a portable multimedia device. Examples of portable multimedia devices include portable telephones, the Apple® ipod®, various types of personal digital assistants (PDAs), personal hand-held televisions, portable video game devices, such as the Nintendo® DS, Gameboy Advance® or Playstation® Portable, various portable multimedia audio and video players, digital watches and various other devices capable of the display of video in any number of formats.

The term “portable multimedia presentation” and similar terms will be understood to refer to combination of slide and video (including or not including audio, as described above) created for, stored or used upon a portable multimedia device. A portable multimedia presentation coincides with a digital video file including slides and synchronized video capable of being stored or played on a portable multimedia device.

There exist systems and methods in the prior art whereby a user may create audio, video and media synchronization. For example, there exist numerous video editors whereby a user may create video. Video may be of any form and an advanced user of a video editor should be able to combine what appear to be “slides” and synchronized video into a single video file. Video creation in the prior art has been somewhat “clunky” and difficult to an average user. Most video creation software or systems require extensive knowledge of the importance of encoding, codecs and file sizes.

Encoding is the process by which audio-video data is “written” in such a way as to be “read” later by a software video viewer. A codec (“coder-decoder”) is a program whereby video may be encoded (and later decoded for viewing). A codec may be understood to coincide with a video or media “format” analogous to a video being released on VHS or DVD. Codecs are typically incompatible with one another, but are means whereby video data may be stored and replayed for later viewing.

One may describe them as algorithms for storing and then later viewing the video based upon that set of algorithms. There exist, literally, hundreds of varying codecs whereby video may be encoded, compressed (reduced in size for transmission or storage), decompressed or decoded for viewing.

Each codec provides benefits or detriments in relation to other codecs. For example, a particular video codec may provide fairly high-quality video playback, but also create dramatically large file-sizes. Such a codec would be unsuitable for use as “streaming” media over the internet. However, such a codec may be ideal for recording video content to a DVD for providing high-quality video that may be stored in a fixed media format.

Alternative codecs have been expressly designed for streaming content. These codecs are, in contrast, typically unsuitable for use in recording to high quality mediums such as digital versatile discs (DVDs) because they are typically low-quality in playback. However, these codecs typically create substantially smaller file sizes and allow for quick and easy playback or download over the internet.

Furthermore, many codecs are specialized and not all codecs are available to all computer users. Often the “best” codecs are not readily available or freely distributed to many users. The best codecs may be codecs that provide high quality video with much smaller file sizes than are normally associated with a particular quality of video.

Alternatively, they may provide means for a quick loading buffer of video content, allowing the user's computer time to download the rest of the video as a user watches the buffer portion. The lack of availability of some codecs and the difficulty in acquiring necessary or desireable codecs, makes playback of videos using some codecs complicated and difficult for an end-user.

File size, in the field of digital media, as can be understood from the foregoing description of codecs is very important. While the internet is becoming increasingly accustomed to larger and larger file formats due to increasing bandwidth available to users, a quality user experience, especially with streaming media or video, still relies upon relatively small file sizes. The larger the file size, the longer load-time a user will experience. Long load times are not conducive to a positive internet user experience.

Recently, the introduction of commonly available portable video players, such as the Apple® ipod® have greatly increased the demand for portable video content which to view on these portable video players. Additionally, a multiplicity of devices, such as the Playstation® Portable, ipod® video docks, personal digital assistants and mobile phones with the capability to view and/or store digital video have increased this need.

User-created “podcasts” are some of the most-downloaded content for use with portable video players. Podcasts include how-to videos, reviews of movies, personal diaries, commentaries and television shows of varying degrees of production value. Podcasts (and other portable video formats) are typically stored in MPEG 4 video format, but may take on any number of proprietary and non-proprietary formats.

Video editors of the prior art typically enable a user to create multiple formats (using numerous codecs) of audio-visual presentations including podcasts. These formats may vary from large-format high-quality videos suitable for recording to digital versatile discs (DVDs) to small-format lower-quality audio-visual content suitable for upload to an internet website for download and subsequent review as podcasts. Choice of codec is only the final difficulty a user of a typical modern video editor faces.

The editing of video is a complex process, selecting time-frames in which to apply edits or cutting portions of video out cleanly. For example, a clean cut requires the user to apply a “fade” effect, at minimum to a cut or other edit. Otherwise, the video may appear disjointed and choppy.

Additionally, as described above, the use of these video editors requires somewhat extensive knowledge of video formats, codecs and file sizes to be used effectively. All of this type of knowledge is required in addition to an understanding of recording, the ability to turn on, and the ability to edit videos with which the user is dissatisfied. The method to create video using a computer is still largely foreign to the vast majority of computer users and is a relatively user-unfriendly task.

If a user desires to create a podcast for one or more portable video players, that user must further know the codecs or video formats that are able to be viewed on a particular portable video player. The user must select to encode that video in one of the select few formats. Additionally, a user must create the content with a level of encoding capable of being easily downloaded to the portable video player.

Once a user has created a podcast or other portable video format, the sharing of the created portable video content has, in the prior art, added additional complications. A user must have knowledge of a file transfer protocol (FTP) or a hypertext transfer protocol (HTTP) to upload the video or podcast to a web server for download and review. Should the user lack knowledge of file formats and attempt to upload a large file, the video sharing would be frustrated.

Furthermore, the upload process takes time. In larger file-formats, the upload process for sharing may make up the most time consuming portion of the video creation and sharing process. Alternate methods exist whereby a user may upload to a video sharing site that converts the video into a video that is able to be shared, including means by which uploaded video may be turned into a podcast, but these prior art systems and methods do not provide all of the functionality that a user may desire in sharing video and pictorial content simultaneously as a multimedia presentation in a user-friendly fashion.

While a user may use video editing software, commonly available in the prior art, to create video and then to hard-code synchronization with a media presentation, it is “clunky”, complicated and difficult. In fact, this process is so convoluted to the average computer user, it is virtually never done. It is rare to even find a computer user who works with video on the internet, much less a user who synchronizes slides with that video.

There further exist other software products designed for the purpose of synchronizing video to slides. However, these software products retain far too much of the complex functionality of video editing software and the selection of storage or transmission means to be usable by the majority of modern computer users. None of these products provides the functionality to create combined slide and video presentations and to then store them as portable multimedia presentations for viewing on portable multimedia devices.

There exist other products in the prior art for creating podcasts (or other portable video format). Typical video editing software of the prior art are capable, often at the click of a button, of creating a podcast out of any video creation that a user has made. However, no prior art method or device provides functionality such that a user may easily create a podcast or other portable multimedia presentation including a combination of video and a slideshow presentation with ease.

For these reasons, there presently exists a need for simple means whereby a user may synchronize an audio-visual presentation and pictures or “slides” and then easily create a combined portable multimedia presentation. No method in the prior art exists for creating a portable multimedia presentation for transmission, storage and review later on a portable multimedia device as a podcast (or similar portable video).

There exist no systems or methods in the prior art whereby a user may create portable multimedia presentations and easily upload them to a target site. There further exist no systems or methods whereby a user may easily edit, manage and publish portable multimedia presentations.

### SUMMARY OF THE INVENTION

The invention provides a system and method for creating portable multimedia presentations. In summary, the system and method of this invention allows a user to quickly, easily and intuitively create a combination video and “slide show” presentation and to subsequently store, share and view that “slide show” on one or more portable devices. The preferred embodiment of the present invention provides numerous benefits over the prior art.

The present invention provides a user with a way in which to select a series of slides, using a graphical user interface within software. Next, a user creates or selects audio and/or video to synchronize with the slides. Next, the user is presented with a single button or menu-element click within the graphical user interface for creating a portable multimedia presentation.

In the preferred embodiment, the portable multimedia presentation created is a “podcast” suitable for use with Apple® ipod® devices. However, in alternate embodiments, it is to be understood that portable multimedia presentations may be created in any number of formats for any number of portable multimedia devices. Formats may include MPEG, AVI, ASF, ACC, WMV, and other video formats. Portable multimedia devices, as described above, may include ipod® devices, MP3 players, portable phones, portable video display devices, wrist watches, portable televisions and the like.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 shows the system used to create a portable multimedia presentation.

FIG. 2 shows a flowchart of the steps involved in the method of the invention.

FIG. 3 shows the graphical user interface of software that embodies the system and method of the invention.

FIG. 4 shows a popup window embodying a portion of the graphical user interface whereby a user may select to create a portable multimedia presentation.

FIG. 5 shows the root directory of a multimedia presentation.

FIG. 6 shows the Slides directory of a multimedia presentation.

FIG. 7 shows the root directory of a multimedia presentation, now including a portable multimedia presentation file.

### DETAILED DESCRIPTION OF THE INVENTION

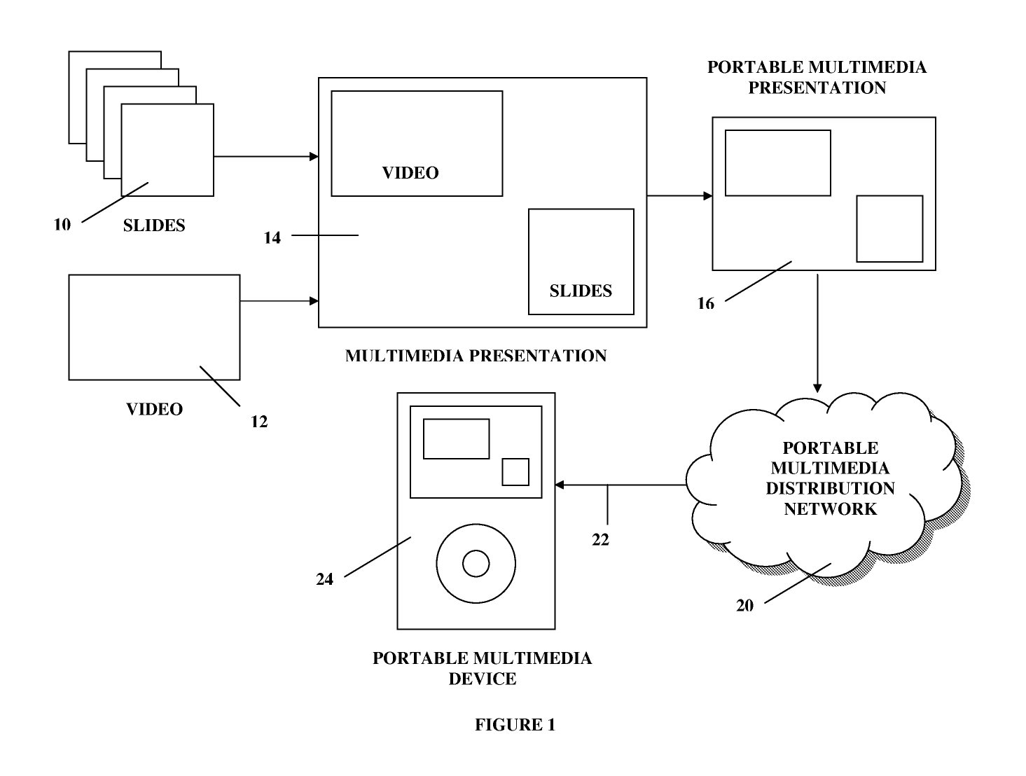

Turning first to FIG. 1, the system of the preferred embodiment is depicted. The system of the preferred embodiment includes multiple elements. The first element is the slides 10. The slides 10 are representative of a group of images or presentation slides (such as Powerpoint® presentation slides). Slides are to be understood in the context of this application to mean any single or series of text, images or combination thereof that, when viewed in sequence, provide a description such as may be used when creating a presentation to be seen by others.

Next, the video 12 is depicted. The video 12 may be created specifically to coincide with the slides 10. The video may be created at the same time or substantially the same time as the slides. Alternatively, the video 12 may be created while reviewing each slide. In yet additional alternative embodiments, video 12 may be selected from an already-created repository of video 12 to be associated with one or more slides.

Video 12 may also come from concurrently-created video. That is, video 12 may be created by a user while reviewing the slides using software designed to capture the video 12 and to synchronize the video with the currently-viewed slides or images.

The video and slides are combined using software 13 embodying the method of the present invention such that it creates a combined slide and video multimedia presentation. In the preferred embodiment, the multimedia presentation is stored as a video portion (or portions) and a series of jpeg images read in conjunction with an extensible markup language (XML) data file.

The multimedia presentation may be understood to represent the combination of video and slides such that the video discusses the slides or elaborates upon them in some way so as to describe or elucidate upon their content for purposes of description.

The slides may be, for example, a series of photographs from a trip or family outing. In this example, the combined audio and video may be a description of the trip family outing or the scenario in which the photographs were taken. In an alternative example, the slides may be Powerpoint® slides for use in a business meeting, wherein the video is a description of the business-related subject matter of the Powerpoint® slides.

The next element is the portable multimedia presentation 16. At this point in the system, the software is used to create a smaller version of the multimedia presentation than may be used in creating the default multimedia presentation. In the preferred embodiment, the portable multimedia presentation is a single video file incorporating both the slides and the video, utilizing a codec suitable for smaller file sizes while retaining sufficient quality such that the slides are legible when reproduced on the displays of portable multimedia devices 24.

In the preferred embodiment, the single video file created is an mpeg video file (of various codecs). In alternative embodiments, a video file protected by digital rights management (DRM) may also be used such that the file is not able to be readily copied.

Next, the portable multimedia presentation 16 is uploaded 18 to a portable multimedia distribution network 20. One embodiment of such a portable multimedia distribution network 20 is the Apple® iTunes™ store. Alternatively, the portable multimedia distribution network 20 may simply be the internet or a particular internet site dedicated to the storage and distribution of portable multimedia presentations.

Alternatively, the portable multimedia distribution network 20 may be the computer of the creator of the portable multimedia presentation. The computer may be, for example, on a network or include access to a network drive within a home or corporation.

The portable multimedia distribution network 20 may be a shared-access hard drive or file shared via a computer on a network. Alternatively, it may not be explicitly shared at all, but simply accessible to the creator of the portable multimedia presentation.

Finally, the portable multimedia presentation is downloaded 22 by a user (or automatically by software) to a portable multimedia device 24. It is to be understood that the portable multimedia device may be of many types. Alternatively, the portable multimedia device may also be used to display the portable multimedia presentation in a large-scale scenario, such as in a board room, a movie theatre or other location.

The end display location of the portable multimedia presentation 16 does not change the step wherein said multimedia presentation is converted, in the preferred embodiment, into a single video file containing all of the elements of the multimedia presentation 14.

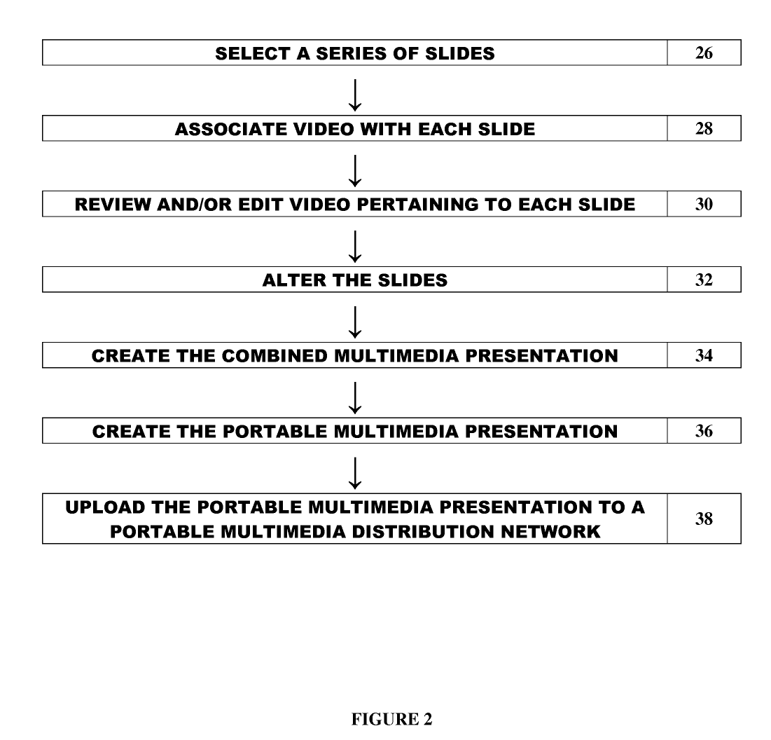

Referring now to FIG. 2, the steps involved in creating a portable multimedia presentation 16 (from FIG. 1) are shown. The “slide selection” step 26 is the first step of the preferred embodiment. In this step a user utilizes images or a presentation (slides, as defined above) stored on a computer, a network, a portable device or remote location. These slides are selected to be incorporated into the combined multimedia presentation including slides and video.

It is to be understood that only one slide need be selected in order to involve the method of this invention. However, multiple slides are selected in most uses of the system and method of this invention.

The “associate video” step 28 is the next step in the preferred embodiment. Association of video may involve the creation of video, for example, specifically for and coinciding with a particular slide. Alternatively, the association of video may be the selection of video already-made, from a local computer, a network, a remote location or portable device.

It is to be understood that video need not be associated with every slide. In fact, one or more slides may have no video associated, while others do. In these instances, the system and method of this invention may still be used.

Alternatively, the “associate video” step 28 may also be used in conjunction with a pre-created video and may be, instead, the first step in the method of this invention. In this embodiment, the video is first selected and slides are associated with particular times, events or elements within the video. The slides to be associated may be incorporated through any number of importation or association methodologies including designating times for each transition from slide to slide or changing slides at signals pre-existing or created in the video.

The “review and/or edit video” step 30 is the third step in the preferred embodiment. In this step, the video may be removed, rerecorded, altered, edited or entire slides and video combinations may be removed. In this step in the preferred embodiment, a user may rerecord the video (in the event of a mistake or inaccurate information) pertaining to a particular slide.

This editing process also allows a user to “trim” a video portion. For example, if the video portion associated with a particular slide is suitable for its purpose except for the first or last few seconds of the clip, a user may “trim” the final few seconds (or minutes or other period of time) from the video. The software of the preferred embodiment automatically inputs a proper transition to mask the trim and properly associates the remainder of the video with the appropriate slide.

This trim functionality can be particularly useful in the event of an unexpected background noise or other video or sound anomaly in the recording of an otherwise suitable video. This enables a user to simply remove the small portion of unsuitable video and continue creating or associating appropriate video without the need to re-record.

Once the video is rerecorded, it is placed in the proper order and a soft transition, such as a fade out/fade in transition is added between the two portions of video associated with the slides immediately preceding and succeeding the slide with associated edited video. This allows the transition between the video of the three slides to appear more smooth than without an edit.

The “alter the slides” step 32 allows a user to alter the order of any slides in relation to the video. In this step, a user may move one or more slides to other locations within the slide show. As the slides are moved, the associated video is cut and moved along with the slides. Again, appropriate transitions are added to smooth over the edit.

The “alter the slides” step 32 also allows a user to replace or remove any one or more of the slides in the presentation portion of the multimedia presentation. If slides are removed, appropriate transitions are added to smooth over the edit. In the preferred embodiment, if slides are removed, the associated video is also removed by default. In alternative embodiments, the video may remain and be automatically associated with the preceding slide(s).

By way of an example, a user may create a video file and utilize a “blank” slide in order to take the place of a slide that will be incorporated later. The user may subsequently replace that one slide with the newly-created slide, thereby associating the video previously associated with the blank slide with the newly-created slide.

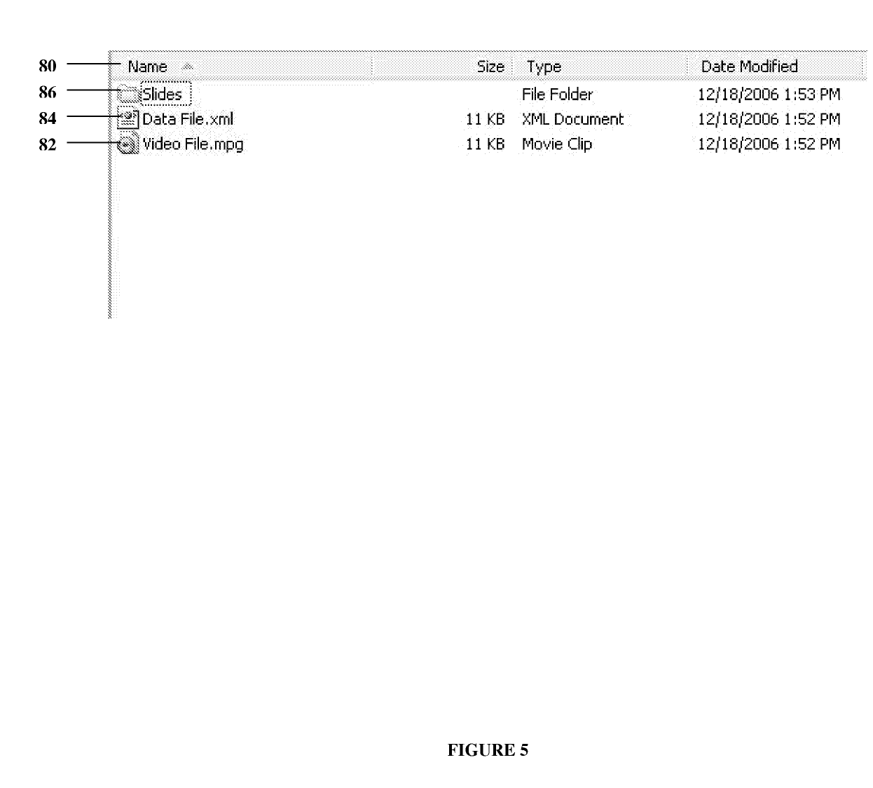

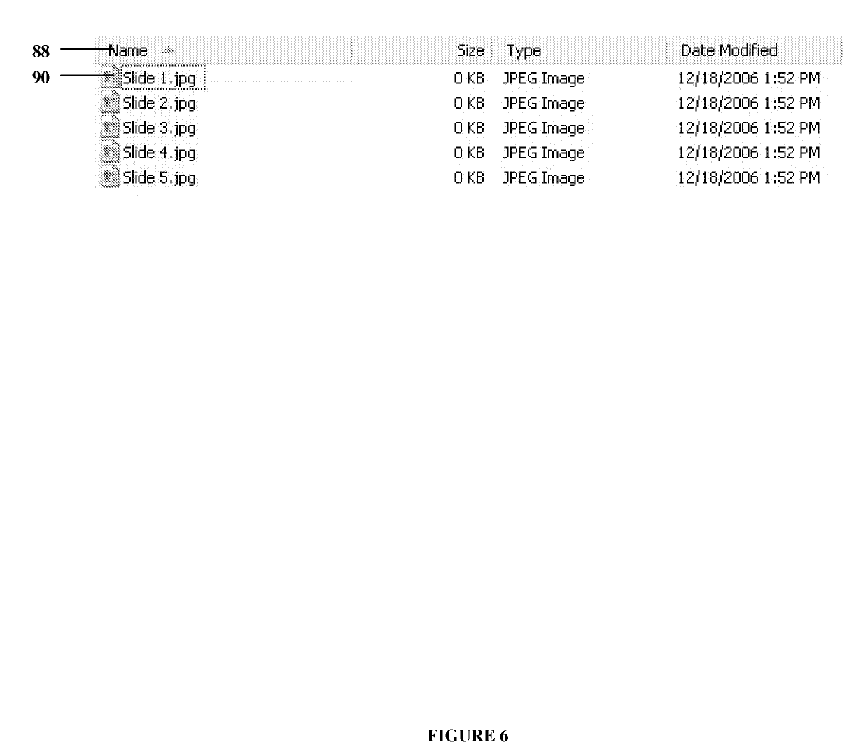

In the “create” step 34 the user may create the combined multimedia presentation. In this step, the software is used to incorporate all of the elements of the multimedia presentation for subsequent viewing. In the preferred embodiment, a multimedia presentation (see FIGS. 5 and 6) takes a particular form. The video is saved in a single file, the slides are saved, as jpeg files in a subdirectory and metadata associated with the multimedia presentation.

Included in this metadata are title, chapter, author and other data related to the presentation and signals indicating at what points in the video each slide is intended to progress. In the event of an edit, the video file is returned to a single file and the metadata is updated. In the preferred embodiment, the metadata is stored in the form of an Extensible Markup Language (XML) file.

In the create portable multimedia presentation step 36 the metadata stored in the meta file, the video and the slides (stored as jpegs in the preferred embodiment) are all incorporated into a single video file. This is done utilizing a scripting language designed to “read” elements within the meta file and to thereby execute a series of commands using video editing software. These series of commands incorporate all relevant portions of slides, audio and video including metadata (such as titles, chapters, authors and other elements described below) into a single, portable multimedia presentation file.

In the prior art, numerous methods exist whereby video files incorporating all manner of elements may be created. However, the present invention, with a single click, is able to create a portable multimedia presentation out of a previously-created multimedia presentation. In well-known methodologies, the invention utilizes something similar to a “save as” function, whereby a user may save a multimedia presentation as a portable multimedia presentation.

The next step 38 is to upload the portable multimedia presentation to a multimedia distribution network. In the preferred embodiment, a user may create a portable multimedia presentation and it is immediately uploaded to a pre-selected or to a selected portable multimedia distribution network. It is to be understood that this step is optional and may or may not take place.

For example, a business user of the present invention may create a portable multimedia presentation. The user may wish his fellow-workers to view the presentation and the business may possess access or manage a portable multimedia distribution network locally or utilize some large-scale multimedia repository service (such as Akamai). The portable multimedia presentation is created and, because the business user is a member of a particular business, uploaded automatically to the selected portable multimedia distribution network.

If a user is the creator a free “podcast” available on, for example, the iTunes® music store, the software may automatically upload the file to the repository designated for updates to a particular “podcast.” Alternatively, a user may select to store it locally or to upload it to one's own portable multimedia device. In yet other alternative embodiments, nothing may be done, immediately, with the file created.

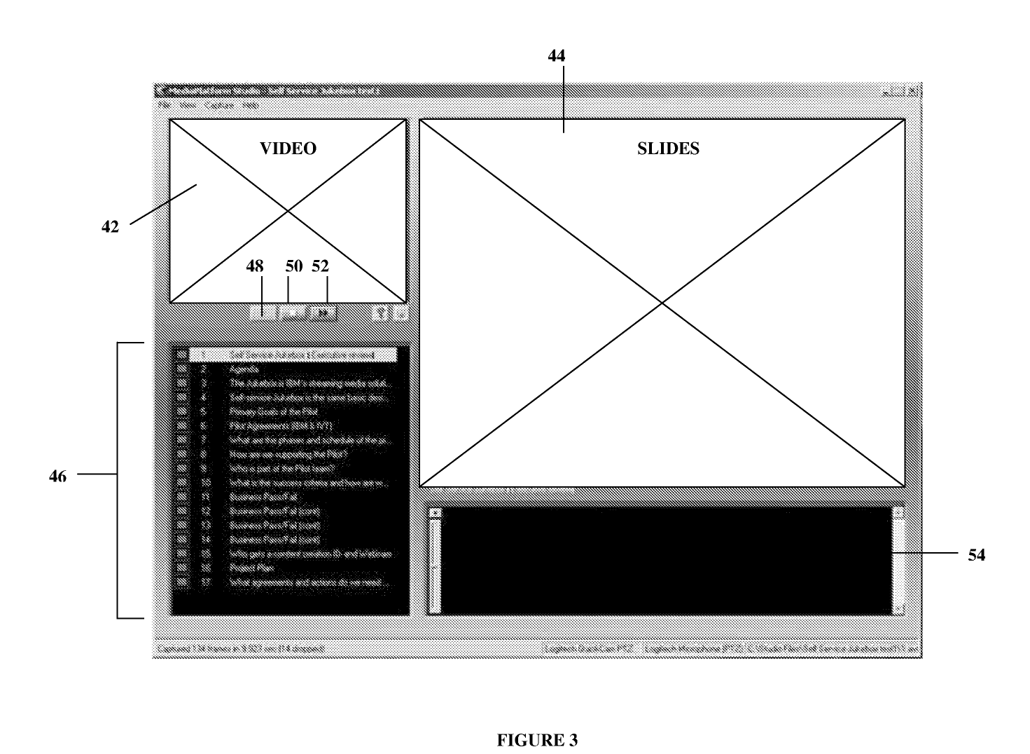

Referring now to FIG. 3, an example of a graphical user interface embodying the slide selection, video association and multimedia presentation creation steps of the preferred embodiment is depicted. It is to be understood that this graphical user interface is merely representative of one embodiment and may be changed in whole or in part while still being capable of the method of this invention.

The first element is the focus window 40 wherein the actions of the user are interpreted to effectuate various results. The video window 42 is used to create or review video associated with a given slide. The slides window 44 is used to view, edit, replace or review slides associated with a given portion of video.

The video window 42 is, in the preferred embodiment, operated by three buttons. The record button 48 is used to begin recording video to associate with one or more slides. The stop button 50 is used to stop recording for a slide or for an entire group of slides. The next slide button 52 is used to continue recording video, while associating that video with the next slide of the series of selected slides. In the preferred embodiment, this creates a “marker” in the metadata associated with the multimedia presentation alerting viewing software of the transition from one slide to another.

The next element is the slide list 46 wherein a listing of the slides currently selected are displayed. A user may go directly to the portion of the multimedia presentation associated with a particular slide (and associated video file portion) by selecting one of the slides listed within the slide list 46.

Additionally, a user may select a slide listed in the slide list 46 and remove it, move it further up in the slide list 46 or move it further down. Multiple slides may be removed, moved or video associated with one or more slides may be rerecorded (or reselected) using the record button 48 after selecting the slide or slides in the slide list 46.

A user may input comments associated with a slide or other notes into the comment box 54. These may include outlines for a subsequent reviewer of the multimedia presentation, comments on the presentation or other information relevant to the multimedia presentation.

It is to be understood that various embodiments of the application used to create multimedia (and portable multimedia) presentations may be used. More complicated embodiments, allowing a user much more control over the layout of the video, slides and associated backgrounds to the presentation may be used. Alternatively, systems whereby a user may only select slides, video and a presentation, layout and upload is all completed for the user.

In yet other alternative embodiments, as are described in the co-pending patent application with Ser. No. 11/562,377 filed Sep. 21, 2006 and entitled “System and Method For Creating Interactive Digital Audio, Video and Synchronized Media Presentations” owned by the assignee of record of the present application, the user may create the multimedia presentation using a web-based software program and subsequent “sharing” means may also include a link to a created portable multimedia presentation. All of these embodiments, and more, are envisioned in the present embodiment.

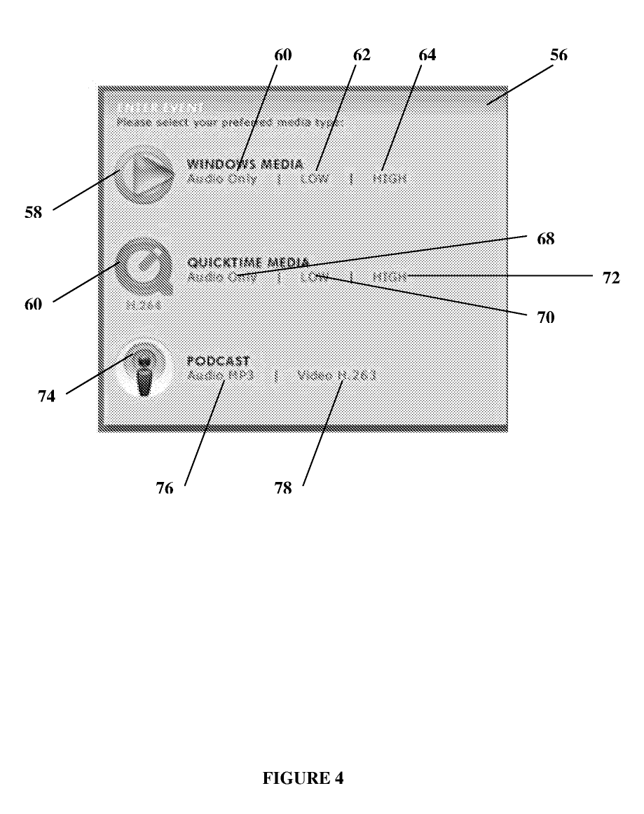

Referring next to FIG. 4, a depiction of a pop up window in a software application enabling the creation of portable multimedia presentations is shown. The first element is the popup window 56. This window 56 appears when a user selects to “save a multimedia presentation as” within the context of menus disposed within the software shown in FIG. 3 (or similar software as described above).

The first option 58 is to save the file as Windows® media. This option presents three additional options. The first is audio only 60, the second is low 62 and the third is high 64. The audio only 60 option allows a user to save the presentation as audio only in a Windows® media file (“WMV”). In the preferred embodiment, this creates a WMV file (as is known in the art) including slides only (no video) and the associated audio. In alternative embodiments, this may create only an audio file, such as a Windows® media audio (“WMA”) file.

The second 62 and third 64 options respectively create low-quality and high-quality WMV files. The low 62 file selector creates a smaller, but lesser quality file. The high 64 file selector creates a larger, and higher quality file.

The next option 66 is the Quicktime® media option. In this option, the file may also be saved as audio only 68, low 70 or high 72 quality video. In the audio only 68, as described above, the file is created showing only the slides and the accompanying audio. In the low 70 and high 72 options, the video, audio and associated slides are all incorporated into a QuickTime® media file.

The final option 74 allows users to create Podcasts (a particular type of portable multimedia presentation, well known in the art). It is to be understood that WMV, WMA and QuickTime® files may also be used as portable multimedia presentation files as well, but the preferred portable multimedia presentation is created using this option 74.

The first selectable podcast 74 is audio MP3 76 which creates an MPEG Layer 3 file, suitable for play in virtually every MP3 or portable audio player. The second option, video H.263, seen in element 78, creates a well-known video file format utilizing the H.263 video codec. This video is suitable for display on ipod® devices and virtually all other various types of portable multimedia devices 24.

Next, as described with reference to FIG. 1, the media file of whatever type is uploaded to a portable multimedia distribution network 20 (See FIG. 1) for distribution. In the preferred embodiment, this takes place automatically. In alternative embodiments, this may not take place at all and the created file may be uploaded, instead to a single user's portable multimedia device 24.

Referring next to FIG. 5, a depiction of the file structure of the preferred embodiment of multimedia presentations is depicted. It is to be understood that this file structure is merely representative. In alternative embodiments, the file structure may be present on a remote server, using a different type of operating system or file hierarchy. However, the overall structure of the arrangement of elements generally remains consistent throughout all embodiments.

The presentation directory 80 is shown including the various elements. It is to be understood that the presentation directory 80 may be of many types, of various names and may include other subdirectories and other elements.

The first element within the presentation directory 80 that makes up a part of the multimedia presentation is the video file 82. In this example embodiment, the video file 82 is a MPG file, a video file of common availability. In the preferred embodiment, a single video file stores all of the video and audio data associated with the multimedia presentation. As discussed above, the single video file is then edited, utilizing audio/video editing software, when slides (and their associated video and audio) are moved, deleted or replaced.

The next element depicted is the data file 84. The data file 84 is a meta file storing all manner of data related to the multimedia presentation. Most notably, the time (in the associated video file) at which slides are to transition is included in this meta file.

Additionally, on-screen displays, captions, notes, comments, chapter headings, titles, references, web links and other data pertaining to the multimedia presentation are included in the data file. In the preferred embodiment, the data file 84 is an XML file (as described above). In alternative embodiments, the data file 84 may be a text file, a document file, a portable document file, a spreadsheet file or may be integrated into a particular type of video or photo image file.

Next, the slides folder 86 is depicted. This folder, a subdirectory of the main folder in the preferred embodiment, holds the slides to which the video file is synchronized. As slides are deleted or moved, the video file in the presentation directory 80 is edited accordingly.

Referring now to FIG. 6, the slides directory 86 (see FIG. 5) is shown. The slides directory 88 (in this Figure) contains a series of slides used in the multimedia presentation. An example slide, slide 1, is shown in element 90.

It is to be understood that the folders shown in FIGS. 5 and 6 are representative of the file structure of the preferred embodiment of a completed multimedia presentation. In the event that such a presentation were to be uploaded for review at another location, the entire directory structure is uploaded, including the video file 82, the data file 84 and the slides directory 86 (or 88 in FIG. 6). This is the preferred method of creating multimedia presentation in the prior art.

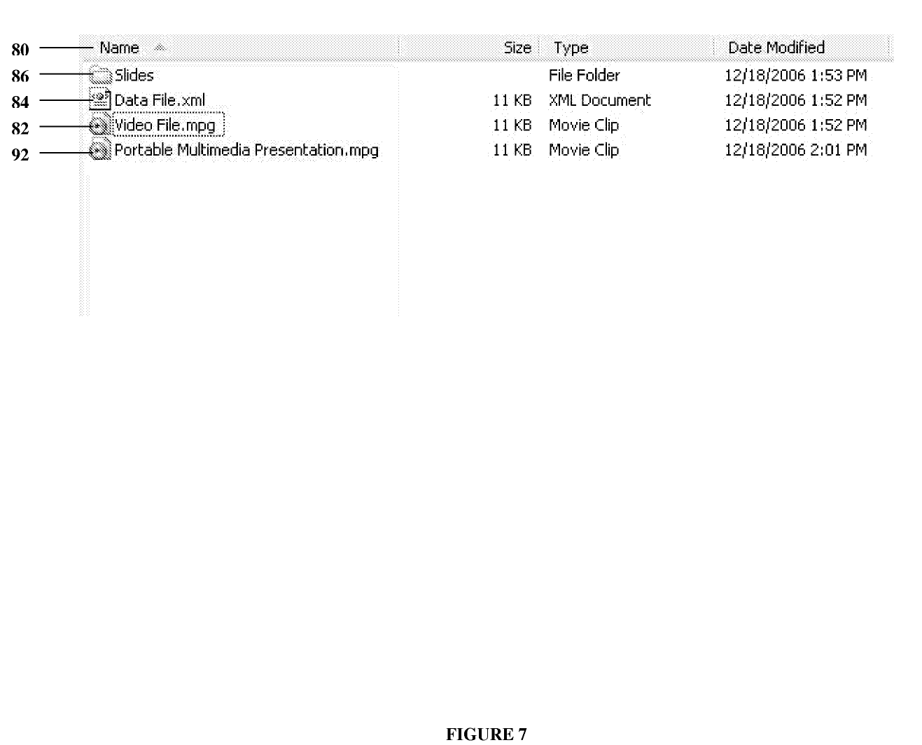

Referring next to FIG. 7, the presentation directory 80 of the multimedia presentation is shown after the creation of a portable multimedia presentation. Still depicted are the video file 82, the data file 84 and the slides directory 86. The newly-created file is now in the presentation directory 80, the portable multimedia presentation file 92.

The portable multimedia presentation file 92 is a single video file including all of the elements in the presentation directory 80. The video, audio and slides are included, as they are laid out in the larger multimedia presentation. The meta data within the data file 84 is also included, such as titles, transitions, authors, chapters and other information.

The file created is a single, easy-to-download, easy-to-transport file. All data is integrated into a single video file such that it may be viewed on a multiplicity of devices without requiring the installation of additional software. In prior art embodiments, the non portable (or regular) multimedia presentations are made up, as has been seen, of multiple files, requiring the use of specialized software to view the presentation. Video viewing software and portable multimedia devices capable of viewing video are ubiquitous.

As above, this portable multimedia file 92 may then be uploaded to a remote directory, put on a portable multimedia device 24 or provided to a portable multimedia distribution network 20. It may then be reviewed by anyone with access to the file and a portable multimedia device 24.

Accordingly, a system and method for creating portable multimedia presentations is described. It is to be understood that the foregoing description has been made with respect to specific embodiments thereof for illustrative purposes only. The overall spirit and scope of the present invention is limited only by the following claims, as defined in the foregoing description.

What is claimed is:

1. A method for creating portable multimedia presentations comprising the steps of:
selecting at least one slide;
associating video with said at least one slide to thereby create a multimedia presentation comprised of the combination of said at least one slide and said video; and
creating a new video file including the elements of said multimedia presentation in a format suitable for storage on a portable multimedia device.

2. The method of claim 1 wherein said multimedia presentation is made up of a multiplicity of slides and associated video.

3. The method of claim 1 further comprising the step, prior to said creating step, of associating video with a second slide to thereby create a multimedia presentation made up of multiple slides;

4. The method of claim 1 wherein said associating step comprises using a camera to capture video to associate with said at least one slide.

5. The method of claim 1 wherein said associating step comprises selecting a pre-existing video file to associate with said at least one slide.

6. The method of claim 1 wherein said at least one slide is a digital image.

7. The method of claim 1 wherein said at least one slide is a Powerpoint® slide.

8. The method of claim 1 further comprising the final step of uploading said portable multimedia presentation to a portable multimedia presentation distribution network.

9. The method of claim 1 further comprising the additional step of replacing a slide with a replacement slide.

10. The method of claim 1 further comprising the additional step of editing said video prior to creating said multimedia presentation.

11. The method for creating portable multimedia presentations comprising:
selecting a series of slides;
associating video with said slides;
creating meta-data whereby transitions between said slides may be triggered through the simultaneous playback of said video;
creating a multimedia presentation made up of said video, played in conjunction with properly-timed transitions between said slides determined utilizing said meta-data;
creating a portable multimedia presentation in the form of a new video file, wherein the contents of said multimedia presentation are all incorporated into said new video file; and
wherein said new video file utilizes a file format suitable for use on a portable multimedia device.

12. A system for creating portable multimedia presentations comprising:
means for accepting as inputs video and at least one slide;
means for associating said at least one slide with said video;
means for combining said at least one slide with said video according to said association to thereby create a multimedia presentation; and
means for transforming said multimedia presentation into a portable multimedia presentation, wherein said portable multimedia presentation is made up of a single video file suitable for playback on a portable multimedia device.

13. The system of claim 12 wherein said means for accepting includes computer software capable of accepting said video and said at least one slide.

14. The system of claim 12 wherein said means for associating includes computer software capable of creating a data file for storing data regarding which of said at least one slide is associated with a portion of said video.

15. The system of claim 12 wherein said means for combining is computer software for producing a video file, given input of said video and said at least one slide.

16. The system of claim 15 wherein said video file is in a format suitable for storage and playback on a portable multimedia device.

17. The system of claim 12 wherein said means for transforming is computer software capable of accepting said video, said at least one slide and instructions suitable for defining the way in which said video and said at least one slide are to be combined and of thereby creating a single video file from said video, said at least one slide and said instructions.

18. The system of claim 12 wherein said means for accepting, means for associating, means for combining and means for transforming are all incorporated into a single software application.

19. A system for creating portable multimedia presentations comprising:
means for accepting as inputs video and a multiplicity of slides;
means for associating said multiplicity of slides with portions of said video;
means for combining said multiplicity of slides with said video according to said association of individual slides within said multiplicity of slides with said portions of video to thereby create a multimedia presentation;
means for transforming said multimedia presentation into a portable multimedia presentation, wherein said portable multimedia presentation is made up of a single video file suitable for playback on a portable multimedia device; and
means for sharing said portable multimedia device with a multiplicity of portable multimedia devices.

20. The system of claim 19 wherein said means for sharing comprises a network repository.
